(19) United States
(12) Patent Application Publication
(10) Pub. No.: US 2012/0067304 A1
(43) Pub. Date: Mar. 22, 2012

(54) Economical hybrid fuel

(76) Inventor: Robert Jon Littmann, Peoria, IL (US)

(21) Appl. No.: 13/200,098

(22) Filed: Sep. 16, 2011

Related U.S. Application Data
(60) Provisional application No. 61/403,477, filed on Sep. 16, 2010.

(51) Int. Cl. F02B 43/10

(52) U.S. Cl. 123/3

(57) ABSTRACT

One embodiment of an improved method for reducing engine system (10) fuel requirement comprised of recovering engine (12) waste energy (30) and of converting (60) engine waste energy (30) into usable energy (64)(66); and, a means of re-introducing usable energy into engine (12), whereby engine primary fuel requirement is reduced and air emissions diminished. Other embodiments are described and shown.

### CROSS-REFERENCE TO RELATED APPLICATIONS

This application claims the benefit of provisional patent application Ser. No. 61/403,477 filed Sep. 16, 2010 by the present inventor.

### BACKGROUND

### Prior Art

The following is a tabulation of some prior art that presently appears relevant:

U.S. Patents

| Pat. No. | Kind Code | Issue Date | Patentee |
|---|---|---|---|
| 3,939,806 | | 1976 Feb. 24 | Bradley |
| 4,023,545 | | 1977 May 17 | Mosher |
| 6,257,175 | B1 | 2001 Jul. 7 | Mosher |
| 6,659,049 | B2 | 2003 Dec. 9 | Zagaja |
| 6,783,750 | B2 | 2004 Aug. 4 | Shah |
| 6,820,706 | B2 | 2004 Nov. 23 | Ovshinsky |
| 7,273,044 | B2 | 2007 Sep. 25 | Flessner |
| 7,337,612 | B2 | 2008 Mar. 4 | Skinnes |
| 7,401,578 | B2 | 2008 Jul. 22 | Otterstrom |
| 7,789,048 | B2 | 2010 Sep. 7 | Coffey |

U.S. Patent Application Publications

| Publication Number | Kind Code | Publ. Date | Applicant |
|---|---|---|---|
| 2002011725 | A1 | 2002 Aug. 29 | McMaster |
| 20040144336 | A1 | 2004 Jul. 29 | Zagaja |

### NONPATENT LITERATURE DOCUMENTS

Xiao, F. et al, SAE 2009-01-1830, “The performance of an IDI Diesel Engine having low concentrations of hydrogen in the intake air” (January 2009)

Coker, D. BSST, “Potential of Thermoelectrics for Occupant Comfort and Fuel Efficiency Gains in Vehicle (May 24, 2006)

Nelson, C. R. Diesel Engine Efficiency & Emissions Research (DEER) “Exhaust Energy Recovery” (August 2006) [Rankine Cycle]

Vuk, C. T. John Deere Technical Center, “Electric Turbo Compounding—A Technology Who's Time has Come (March 2006)

### BACKGROUND OF THE INVENTION

1. Field of the Invention

The present invention relates to engines and more specifically to an improved internal combustion engine having an open thermodynamic cycle where air and fuel expand to move a piston, perform work and vent exhaust to the environment and at least one auxiliary thermodynamic cycle that converts wasted engine system energy into electrical and chemical energy which is used beneficially back in the engine system to improve said system fuel efficiency while minimizing air pollution.

2. Description of the Related Art Including Information Disclosed Under 37 CFR 1.97 and 1.98.

The need for more economical energy sources is evident to many Americans. Hybrid automobiles, using electrical energy to reduce oil use, ethanol powered cars and hydrogen engines are all useful. The invention described herein is in alignment with these attempts to provide economical power and transportation while controlling adverse airborne emissions.

Combustion engines are systems that convert chemical energy in the form of fossil fuel or hybrids of various fuels with a low level of efficiency. In 2010, the state of the art of automobile Otto cycle engines, fossil fuel is converted into mechanical energy, with approximately 25% efficiency. In 2010, the state of the art of diesel engines, fossil fuel is converted into mechanical energy, with approximately 30% efficiency. The 70 to 75% fossil fuel energy which is not converted into mechanical energy exits the system predominately as wasted heat. The wasted automobile heat, as a percentage of the original fuel, is comprised of:

| | |
|---|---|
| Exhaust gas, oil & miscellaneous | 40 to 45% |
| Engine Jacket Cooling water | 20 to 27% |
| Friction | 15 to 18% |

Note:
Burke et al

The engine speed, in the case of an automobile, or the engine load, in the case of a truck, will affect the fuel conversion to mechanical energy efficiency within the approximate ranges indicated above.

Automotive Air Emissions Standards have become increasingly stringent since 1955 and as recently as 2010. These EPA Standards seek to protect the environment from nitrous oxides, acid rain, airborne lead, unburnt carbon, etc. Presently, to meet these environmental standards, car and truck manufacturers must install pollution abatement systems that reduce fuel efficiency. Examples of pollution abatement systems include Catalytic Converters, Particulate Matter Filters (PMF), Selective Catalytic Reduction (SCR) systems for NOₓ reduction, Charge Air Coolers (CAC), Turbochargers, etc. Each of these pollution abatement systems directly or indirectly reduces the combustion engine efficiency. Direct reduction of the engine efficiency means that mechanical energy is used for an ancillary purpose rather than driving the power train. Indirect reduction of the engine efficiency means that an opportunity for efficient waste heat energy recovery is directed to some other purpose such as pollution abatement.

In 2005, the DOE developed a partnership with the major engine manufacturers. This partnership, Diesel Engine Efficiency Research (DEER), was focused towards improving engine efficiency while meeting stringent EPA air emission standards. Most of the DEER efforts, which continue through 2010, were directed toward mechanical and engine improvements. There were several recommendations to recover waste heat and convert the energy into electricity using turbo-generators, indirect heat recovery with a Rankine Cycle, and Thermo-Electric Modules (TEM). In each case, the electricity from waste heat was/is first directed to supply electricity to electric accessories, including Air Conditioning Compressors, Air Compressors, water pumps, fuel pumps, fans, blowers, etc. Incorporated into most of the waste heat to electricity devices is a mechanism to also convert the electricity to mechanical energy which is incorporated back into the engine through a series of complex and expensive gears.

Some of the waste energy is recoverable with state of the art technology (DEER) but most of it is not. High temperature (˜450 to 600° C.) energy is partially recoverable; low to medium temperature (˜90 to 450° C.) energy is not economically recovered.

Attempts have been made to utilize the energy available from the heat and exhaust. For Example, U.S. Pat. No. 7,789,048 to Coffey (“Coffey”) described an apparatus for producing fuel for engines from water comprising: a battery and a solar panel connected to an electrolyzer which has separate outlet pipes for the venting of hydrogen and oxygen, a manifold combining the pipes leading to an internal combustion engine, ignition means consisting one of spark plugs and optical igniters in the engine, an exhaust manifold connected to outlets of the engine that directs the resultant steam generated by the combustion of the hydrogen and oxygen in the engine, a steam turbine driven by the steam in the exhaust manifold and an electric generator driven by the turbine which in turns is connected to the battery, a thermostat in the exhaust manifold downstream of the turbine for selectively directing the steam to a radiator to condense the steam into water, a pipe directing the condensed water back to the electrolyzer. The Coffey invention is a closed system which operates as a modified Rankine cycle. The problem with U.S. Pat. No. 7,789,048 is that the only energy input is solar energy but the output energies include engine jacket heat, turbine condenser latent heat of vaporization, frictional losses, parasitic electrical load for pumps, compressors, etc. in addition to the mechanical energy required to power the transmission and power train. The energy required to power the turbine condenser fan is significant and is a limiting factor in the extent of engine waste heat recovery. The overall process efficiency is 25% or less. The method suffers from all of the disadvantages of sporadic solar energy availability, even in the desert and would require an extensive battery. Coffey would be advised to use the solar energy to power electric motor which would be far less complex, cheaper and more efficient. The invention disclosed herein differs from U.S. Pat. No. 7,789,048 in that it is an open system without dependence on solar energy, is simpler, does not require spark plugs or igniters, and provides more efficient use of energy.

Zagaja, et at in U.S. Pat. App. 20040144336 provides a system and method for generating hydrogen for use with an internal combustion engine. The system includes a venturi device coupled with an exhaust stream from the internal combustion engine. The venturi device creates a gas flow through a condenser to generate reactant water. After the reactant water is polished to remove contaminants, hydrogen and oxygen are disassociated using a Proton Exchange Membrane (“PEM”) based electrolyzer. The hydrogen gas is used by the internal combustion engine to assist in the combustion process and reduce pollutant emissions. In Zagaja, the condenser is a thermo-electric cooler which currently have an efficiency to convert thermal energy to electricity at less than 5%. Zagaja employs the electricity from the thermo-electric cooler to electrolyze water into hydrogen and oxygen, the water used for electrolysis into hydrogen and oxygen is recovered from the exhaust gas which causes concentration of the exhaust gas dissolved and suspended solids which quickly exhaust the capacity of the carbon filter and mixed bed resin to remove; the solids in the recovered water will foul the PEM causing high electrical resistance with the effect of boiling the electrolyte causing it to vaporize rather than dissociate into hydrogen and oxygen, the predominate inorganic dissolved solids are nitric acid, sulfuric acid (to the extent that sulfur is in the fuel) and carbonic acid; these acids will concentrate in the electrolyzer thus reducing its efficiency and ultimately recycle back into the engine air intake causing increased air pollution. The energy to cool the thermo-electric cooler will exceed the energy potentially produced by the thermoelectric cooler thus causing a negative energy input to the system rather than a positive energy gain. The invention disclosed herein differs from U.S. Pat. No. 6,659,049 in that the energy used for water electrolysis is recovered from the engine system waste energy, waste air emissions are not recycled and concentrated, the electrolyzer cell efficiency is very high, substantial air emissions are abated and substantially more primary energy is reduced as input to the engine.

McMaster, et at in U.S. Pat. App. 20020117125 suggest a closed loop fuel system for an internal combustion engine, including a water tank, in which water is electrolyzed to provide hydrogen and oxygen gases that are pressurized for storage in respective tanks for flow to the engine and combustion prior to exhaust flow to a condenser and recycling back into the water tank. The fuel system includes an auxiliary water supply that lowers the burn temperature of the engine and provides additional steam under pressure for operation of the engine as well as providing cooling of the exhaust steam condensed by the condenser. Water is electrolyzed into hydrogen and oxygen at a stationary site with said hydrogen and oxygen stored and consumed on-board the vehicle as needed, or imported electricity is used to charge batteries and water is electrolyzed as needed. A photovoltaic panel can be used to electrolyze the water and provide the hydrogen and oxygen gases. McMaster, et al has essentially suggested an electrical powered vehicle with a Rankine Cycle variation. There is no recovery of wasted energy. The invention disclosed herein differs from U.S. Pat. App. No. 20040144336 in that it is an open system which uses recovered waste energy to electrolyze hydrogen and oxygen which are advantageously used back within the engine system to increase primary fuel efficiency while controlling airborne emissions.

Otterstrom, et al, in U.S. Pat. No. 7,401,578 provides a system that draws waste heat from an open-loop engine cycle into a closed-loop working fluid which said waste energy rotates a shaft in a wankel or similar type engine connected to a shaft to generate electricity, said electricity is employed to electrolyze water into hydrogen and oxygen, said hydrogen fraction is received by a reformation unit which also receives diesel fuel which are reformed prior to combustion. The invention disclosed herein differs from U.S. Pat. No. 7,401,578 in that it is an open system without a closed-loop working fluid circulatory system, hydrogen and oxygen are introduced into the engine system in a method whereby nitrous oxides and other air emissions are controlled which allows a reduction or practically eliminates Exhaust Gas Recycle which reduces the production of waste energy and allows more waste energy to be efficiently recovered for reuse in the engine system as hydrogen and oxygen.

Skinnes, et al, in U.S. Pat. No. 7,337,612 described a method for operating an engine by cyclic thermochemical processes in place of a combustion reactor. The invention disclosed herein differs from U.S. Pat. No. 7,337,612 in that chemicals other than water are not required, and a spark of some sort is utilized to catalyze the energy producing reaction. A method for the production of mechanical energy from an energy producing unit, comprising feeding a working fluid to an energy producing unit, where the working fluid before entering or within the energy producing unit employs an external energy source to undergo a dissociation and/or chemical reaction causing a direct and/or indirect volume expansion of the working fluid which volume expansion drives the energy producing unit, and wherein the working fluid exiting the energy producing unit is conducted further to a recycling unit, where the working fluid is converted to its initial non-dissociated and/or chemically reacted state before being re-directed to the energy producing unit. The invention disclosed herein differs from U.S. Pat. No. 7,337,612 in that since it the cyclic thermochemical processes have total integrated process efficiencies ranging from 4.7% to a 10.48% they rely on the availability of large quantities of low value waste heat and low cost cooling medium. Thus, they are not efficient users of automotive waste energy, are not suited for mobile engines and have a very narrow opportunity within stationary engines. The invention disclosed herein recovers waste energy at a high level of efficiency and is not a cyclic thermochemical process.

Ovshinsky, et al, presented a hydrogen powered internal combustion engine in U.S. Pat. No. 6,820,706. A hybrid electric vehicle comprising: a throttleless hydrogen powered internal combustion engine including one or more cylinders supplied with one or more unthrottled air streams, said one or more unthrottled air streams being supplied with hydrogen prior to entering said one or more cylinders; an electric motor supplementing said hydrogen internal combustion engine; a rechargeable battery for powering said electric motor; and a metal hydride hydrogen storage unit in gaseous communication with said one or more unthrottled air streams, said metal hydride hydrogen storage unit including a pressure containment vessel at least partially filled with a hydrogen storage alloy. The invention disclosed herein differs from U.S. Pat. No. 6,820,706 in that no hydrogen is purchased, minimal hydrogen is stored, hydrogen metering is self controlling, waste energy is efficiently recovered in a usable form while ambient air emissions are controlled and no supplemental electric motor is required.

Flessner, et al, U.S. Pat. No. 7,273,044, describes an electrolyzer for generating hydrogen and oxygen, exhaust gas being recycled through the electrolyzer, and hydrogen and oxygen stored in pressurized tanks, an air intake port open to the atmosphere, an expander (which is limited in reciprocating engines because it operates at ambient pressure), pressurized tanks, compressors and catalytic converters among other equipment are required which add to the weight and lower vehicle efficiency in the case of transportation embodiments. In addition, pressurized tanks of these gases may lead to spectacular explosions in the event of automobile collisions, which are an everyday event in the US. The invention disclosed herein differs from U.S. Pat. No. 7,273,044 in that significantly more waste energy is recovered beyond the potential of an expander(s), engine exhaust conduit in fluid communication with electrolyzer is avoided, external power supply is avoided, and air emissions are significantly reduced.

Zagaja, et al, suggested a system and a method for generating hydrogen for internal combustion engines in U.S. Pat. No. 6,659,049. In Zagaja, only 0.01 to 0.02% of the equivalent fuel Btu is produced using electricity from the engine driven alternator to electrolyze water into hydrogen and oxygen, the water used for electrolysis into hydrogen and oxygen is recovered from the exhaust gas which causes concentration of the exhaust gas dissolved and suspended solids which quickly exhaust the capacity of the carbon filter and mixed bed resin to remove; the solids in the recovered water will foul the Proton Exchange Membrane causing high electrical resistance with the effect of boiling the electrolyte causing it to vaporize rather than dissociate into hydrogen and oxygen, the predominate inorganic dissolved solids are nitric acid, sulfuric acid (to the extent that sulfur is in the fuel) and carbonic acid; these acids will concentrate in the electrolyzer thus reducing its efficiency and ultimately recycle back into the engine air intake causing increase air pollution. The invention disclosed herein differs from U.S. Pat. No. 6,659,049 in that the energy used for water electrolysis is recovered from the engine system waste energy, no waste condensate is recovered, substantial air emissions are abated and substantially more primary energy is reduced as input to the engine.

Shah, et al, produced a design for a hydrogen production method, creating hydrogen, and involving use of oxygen and hydrocarbons, in U.S. Pat. No. 6,783,750. A method of producing hydrogen comprising: separating oxygen from a heated oxygen containing feed stream with an oxygen transport membrane to produce an oxygen permeate; reacting said oxygen permeate, a hydrocarbon contained in a hydrocarbon containing feed stream, and steam contained in a steam feed stream in partial oxidation and reforming reactions to produce a crude synthesis gas comprising hydrogen, carbon monoxide, water, and carbon dioxide; separating said hydrogen from said synthesis gas in a hydrogen transport membrane to produce a hydrogen-depleted crude synthesis gas and a hydrogen permeate; forming a product stream containing hydrogen composed of said hydrogen permeate; and forming the heated oxygen-containing feed stream by combusting a stream of the hydrogen-depleted crude synthesis gas in the presence of an oxygen-containing feed stream. The invention disclosed herein differs from U.S. Pat. No. 6,783,750 in that significant quantity of waste energy is recovered and efficiently converted to a form wherein it can be reused back in the engine, displacing purchased primary fuel.

Mosher, et al, in U.S. Pat. No. 6,257,175, suggested generating hydrogen and oxygen gases for use in an internal combustion engine in a vehicle using the electrical system of the vehicle to provide current for the electrolysis process to generate the hydrogen and oxygen gases. The electrolysis process to eliminate oxygen and hydrogen gases occurs only while the engine is being operated and terminates when the engine stops. The hydrogen and oxygen gases are collected separately in the generator apparatus and flow separately in their own conduits to the intake manifold of the engine. Water in the generator apparatus is replenished from a reservoir as the water is used, and the water is accordingly kept at a desired level in the generator apparatus. The invention disclosed herein differs from U.S. Pat. No. 6,783,750 in that no energy is drawn from the vehicle electrical system as the electricity to electrolyze water into hydrogen and oxygen is produced from waste energy; also, the method by which hydrogen and oxygen are employed reduce the production of waste energy while substantially reducing air emissions.

Mosher, et al, earlier suggested a gas generating system for use with internal combustion engines, to afford hydrogen gas and oxygen gas to be intermixed with the fuel for the engine in U.S. Pat. No. 4,023,545. Mosher's gas generating system is an energy means for use with an internal combustion engine having a source of electrical energy and an intake manifold for admitting combustion support means to said engine, comprising in combination an electrolysis unit connected in circuit with said source of electrical energy to generate hydrogen gas and oxygen gas, said electrolysis unit comprising a tank having at least one cathode attached to said tank internally thereof, said cathode and said tank being connected to the negative side of said source of electrical energy, and at least one anode placed internally of said tank and spaced from contact with said tank and said cathode and connected to the positive side of said source of electrical energy, said tank being substantially filled with a solution of electrolyte and water, whereby application of said electrical energy to said anode and to said cathode may cause generation of hydrogen gas and oxygen gas from the water; air conduit means extending into said tank beneath both said anode and said cathode such that bubbles of air from said cathode may float upwardly immediately adjacent said anode and said cathode to assist in removing said generated gases from said anode and said cathode; and gas conduit means interconnecting said tank and said engine intake manifold to conduct said hydrogen and oxygen gases to said manifold. In Mosher, the energy required for electrolysis of the water is taken from the engine's electrical system which is produced by an alternator converting mechanical energy from the engine system. The Mosher electrolytic cell is an undivided cell in that electrolyte freely moves unimpeded between the anode and the cathode. The electrolytic cell is presumed to generate an oxidizing agent, oxygen, at the anode and a reducing agent, hydrogen, at the cathode. In an undivided electrolytic cell there are many competing reactions which neutralize or offset the production of oxygen and hydrogen. The net effect is that the efficiency of the system in generating the desired hydrogen and oxygen is substantially reduced. The reduced electrolyzing efficiency causes a net loss to the engine system as follows: The conversion of chemical energy to mechanical energy to electrical energy is approximately 25% or less; the conversion of electrical energy to chemical energy in producing hydrogen and oxygen is less than 100% (in this case significantly less, i.e. 50% or less); thus, 4 Btu's of chemical energy in the form of primary fuel is applied to the engine system for every 1 Btu (or less) of energy returned to the engine system in the form of hydrogen or indirectly as oxygen.

Early attempts have been made to utilize the energy available from the heat and exhaust. For example, U.S. Pat. No. 3,939,806 to Bradley (“Bradley”) discloses a closed circulatory system that generates energy from the exhaust heat of an engine. In Bradley, heat from the exhaust is transferred to a cool working fluid which operates in a closed-loop cycle, which drives a turbine to produce current to a generator. DC current is delivered to an electrolysis cell that produces oxygen and hydrogen by decomposing water. The oxygen is passed to an air intake on the engine and the hydrogen may also be passed to the engine. The working fluid is condensed in condenser to complete the closed loop. In general, Bradley's device has a number of deficiencies. For example, a turbine will typically operate in a very narrow range of performance. Vehicles travel down the road at many variant revolutions per minute, under different loads and at many different speeds. With these variables, the engine cannot produce the narrow range of outputs needed by a typical turbine. Such a turbine does not function efficiently because it is unable to adjust to these described variations based on the loads and other factors. Because of these limitations on the operation of turbines, a deficiency in this system and on its performance exists. Bradley also notes that their system is in communication with the cooling system of the engine block. However, Bradley ignores other heat generated by the engine. Because the Bradley concept fails to take into account other sources of heat beyond the existing cooling system, it is therefore further flawed. Outputs of hydrogen and oxygen are limited by the amount of electricity the system can generate because other heat sources are ignored. In relative terms, the Bradley device delivers very small quantities of hydrogen and oxygen from electrolysis to the engine intake and combines them with ambient air without reforming the fuel prior to ignition. Optimal increase in combustion and decrease in emissions is not achieved. Another deficiency in the Bradley system is the lack of sufficient radiator surfaces to cool the closed loop system. The working fluid in a closed system needs to be cooled properly. Bradley does show a condenser to convert the gaseous form of the working fluid into a liquid again, but there is not a sufficient disclosure with regards to mechanisms for being able to recycle the working fluid in the second closed loop system. The invention disclosed herein differs from U.S. Pat. No. 3,939,806 in that the system is open so that condensing of water vapor to liquid is eliminated as are issues related to variable turbine speed; additionally, waste energy is not transferred to a working fluid which is then used to drive a turbine nor are control of air emissions substantially improved.

### SUMMARY OF THE INVENTION

While it would seem that recovering waste energy and converting it back into mechanical energy is the optimum approach to improving engine system energy efficiency, surprisingly, the present invention recovers waste energy as electricity and reintroduces it back into the fuel to mechanical energy conversion system with greater efficiency, lower cost, less complications and with greater impact on reducing air emission pollutants and greenhouse gases as chemical energy. The net effect is that overall purchased fuel consumption is reduced 20 to 50% or more depending on the engine service duty, number of energy saving devices installed and the baseline efficiency of the engine.

According to the present invention, waste energy is recovered as electricity using Turbo-generators, Rankine Cycle turbines, Expanders and Thermo Electric Modules. Additionally, waste heat is recovered from Regenerative Shock Absorbers, Engine Exhaust Braking and Regenerative Engine Braking devices that are the subject of parallel patents by this inventor. The recovered electricity can first be used to satisfy the parasitic electric load. One embodiment of the present invention will diminish or eliminate the alternator and its diversion of mechanical energy away from the engine in its entirety.

Additional embodiments of the present invention control NOₓ emissions without the use of Exhaust Gas Recycle (EGR) and Selective Catalytic Reduction (“SCR”). Additionally, since combustion is complete, Particulate Matter Filters (“PMF”) are reduced or not required. Also, since EGR is eliminated, Charge Air Coolers (“CAC”) are not required.

Since the present invention allows recovery of more energy than current technology allows and generates electricity, at high efficiency, more than enough to satisfy said parasitic electric load, the present invention converts the extra electricity into hydrogen and oxygen through a highly efficient and self modulating electrolytic cell which is the subject of a related patent, by this inventor. Basic logic affirms that in a process which has the purpose of converting chemical energy to mechanical energy, any recovered energy should be used to produce mechanical energy, the original objective of the process. The inventions of this process clearly show that surprisingly, the overall engine system benefits from improved efficiency by recovering the engine system waste energy as chemical energy and not mechanical energy.

The present patent addresses NOₓ and combustion efficiency improvements in a unique manner. Fundamentally, nitrogen introduced to the engine is dramatically reduced. Since up to 50% of the fuel is generated on board as hydrogen from water, there is concurrently generated oxygen. This oxygen, which is required for the complete combustion of the hydrogen, displaces combustion air requirements. Since air is almost 80% nitrogen, each part of on-board oxygen generated reduces four parts of nitrogen by volume. On a weight basis, stoichiometric basis, combustion of a pound carbon with air requires 13.3 pounds of air. The breakdown of the air would be predominately 2.66 pounds of oxygen and 10.64 pounds of nitrogen. Thus, each pound of on-site generated oxygen reduces 4 pounds of nitrogen introduced into the combustion chamber of the combustion engine.

Since the EGR is potentially eliminated the EGR turbo charger can be used to process all of the make-up combustion air through nitrogen reduction or oxygen enrichment processes. The effect is to reduce as much nitrogen introduction into the combustion engine as practical. There are at least three commercial processes which can reduce or substantially eliminate most if not all of the nitrogen entering the combustion chamber. All of them require that the air be compressed which with the elimination of EGR makes air compression readily available with the turbo compressor. Membrane separation is practiced by a polyamide gas separation membrane which allows oxygen to permeate while rejecting nitrogen. (Nitrogen enrichment membranes may also be practical.) Up to 50% oxygen enrichment is practical using this method. The second method is pressure swing adsorption using molecular sieves which specifically capture oxygen and then release them in a regeneration cycle. With this method, oxygen concentrations in excess of 99% are practical. The third method is cryogenic oxygen production which, while seeming complicated and energy inefficient, may allow oxygen production that is cool or cold. This cool or cold oxygen can be used to recover low temperature waste heat from the engine jacket cooling system or the exhaust system after the muffler and/or enhance thermoelectric module efficiency.

Reduction of air injection into the combustion chamber changes the gas mixture to one which is predominately carbon dioxide and water vapor. The specific heat of this mixture is higher than a carbon dioxide, high nitrogen, low water vapor gas mixture. Thus greater heat is retained for combustion in the power stroke cycle of the engine.

Since the combustion gases of this invention are more than 50% water vapor, the temperature of the combustion engine is tempered; that is, the water vapor cools the combustion chamber by converting some of the sensible heat into latent heat. Without the water vapor, and removal of most or all of the nitrogen contained in the combustion air, the combustion temperature with mostly carbon and oxygen would be too hot and even minimal amounts of nitrogen getting into the combustion system through fractional residual air or as part of the fuel would be converted to NOₓ. Therefore, reduction of nitrogen combined with the injection of a high amount of hydrogen and oxygen which combust to water vapor and control combustion temperature combine to reduce the nitrogen present in the combustion zone and the reduce the conditions under which nitrogen becomes oxidized to NOₓ.

Another embodiment of this invention is to run the combustion phase fuel rich or lean on combustion air. Thus, instead of combusting the fuel in an oxidizing environment, the fuel is combusted in a reducing environment. By doing so, the driving reactions to form NOₓ are dramatically reduced. This does, however, mean that there are unburnt combustibles entering the power stroke cycle. To complete combustion, within the engine, some of the onboard generated oxygen can be directed to the cylinders in the power stroke cycle or downstream of the engine to complete combustion without loss of energy and reduce or eliminate the need for Particulate Matter Filters.

### BRIEF DESCRIPTION OF THE DRAWINGS

FIG. 1 is a simplified schematic diagram of a typical truck/automobile combustion engine system.

FIG. 2 is a simplified schematic diagram of an engine/electric generator system according to the present invention, and

FIG. 3 is a simplified schematic diagram of an engine/electric generator system according to an additional embodiment of the present invention, which includes oxygen injection into the power stroke cycle of the engine.

FIG. 4 is a simplified schematic diagram of an engine/electric generator system according to an additional embodiment of the present invention, which includes oxygen enrichment of the combustion air.

FIG. 5 is a simplified schematic diagram of an engine/electric generator system according to an additional embodiment of the present invention, which includes engine braking exhaust energy recovery.

### DETAILED DESCRIPTION

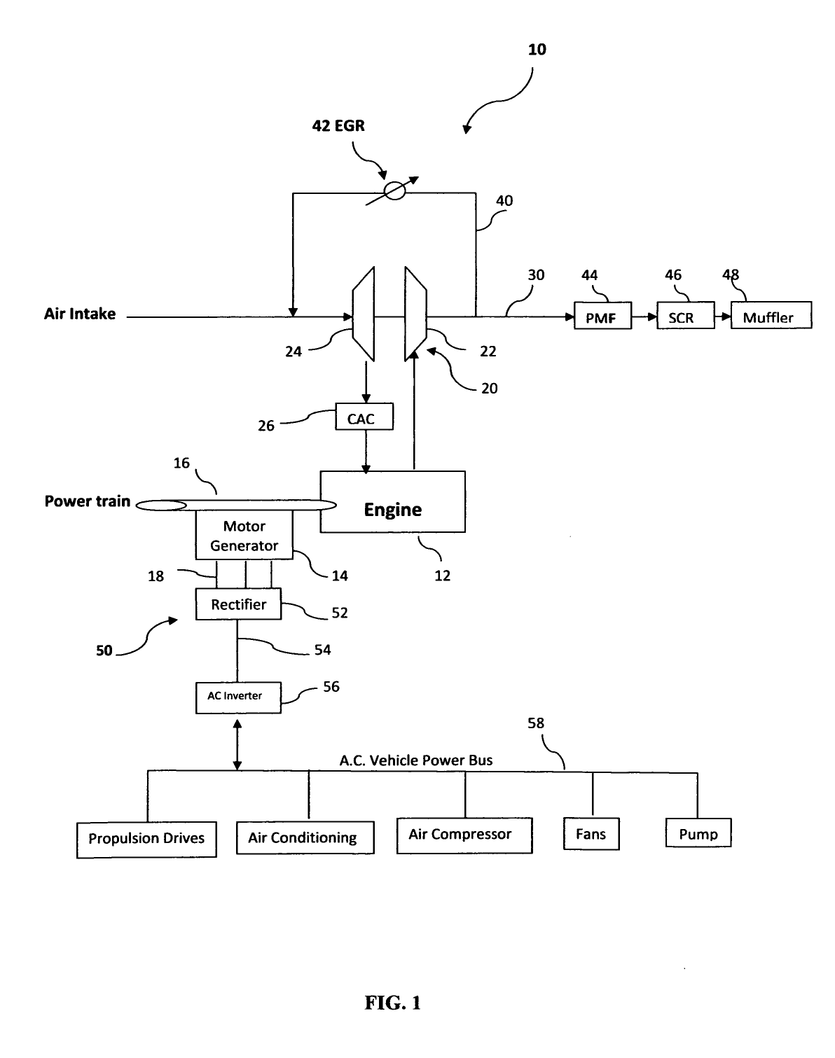

Referring to FIG. 1, an engine/electric generator system 10 includes an internal combustion engine 12, such as a Diesel engine and a primary conventional electric generator 14 driven by the output shaft 16 of the engine 12. The generator outputs electrical power on a set of electrical transmission lines 18. The engine/electric generator system 10 of FIG. 1 is preferably a common generator configuration with a “genset” using constant speed governor control.

A turbocharger 20 includes a turbine 22 driven by exhaust gases from the engine 12 and a compressor 24 driven by the turbine 20 and providing inlet air to the engine 12. Between the compressor and the engine is a Charge Air Cooler 26 to remove some of the heat of compression.

Generator 14 provides 3-phase electrical power to an electrical unit 50 which includes a rectifier 52, a DC bus 54 and an AC inverter 56. Bus 54 connects the rectifier 52 to the inverter 56. The AC inverter then provides AC electrical power on lines 38.

An exhaust gas recirculation line 40 communicates an output of the turbine 22 to an input of the compressor 24, and a valve 42 in the exhaust gas recirculation line 40 controls the flow of exhaust gas recirculation therethrough.

Exhaust line 30 communicates the output of the turbine to post combustion treatment units including Particulate Matter Filter 44, Selective Catalytic Reducer 46 and a muffler 48.

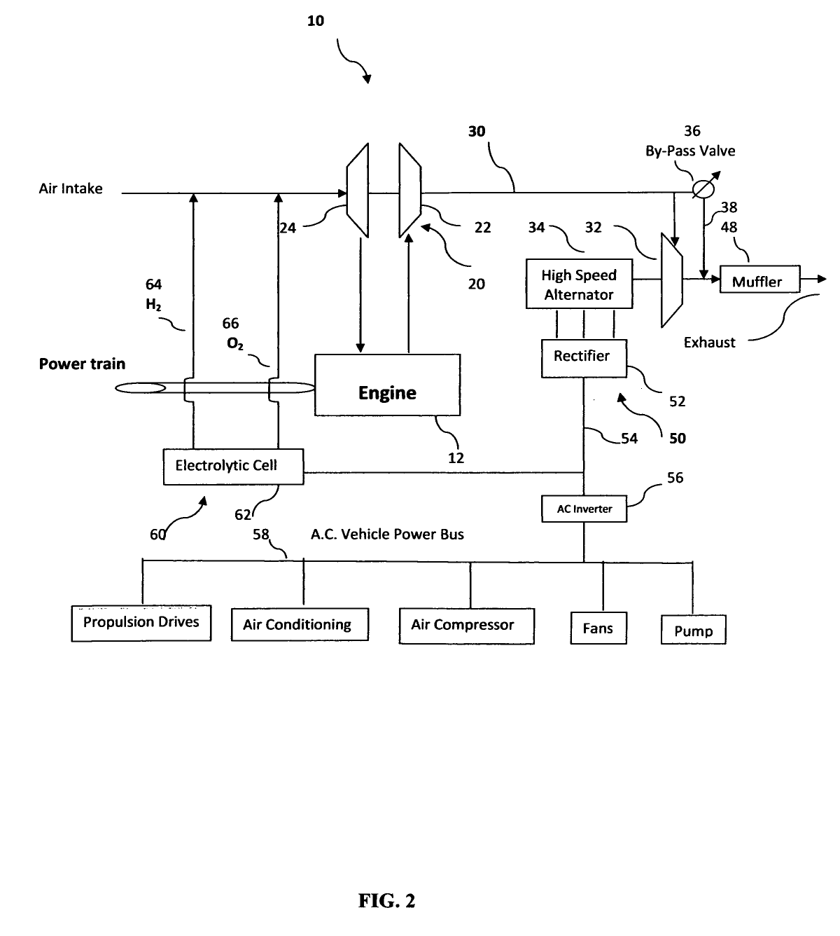

Referring now to FIG. 2, there is shown exhaust line 30 communicating exhaust gas from the first turbine 22 to a secondary turbine 32. A secondary electric generator or “turbo-generator” 34 is driven by the secondary turbine 32. The secondary generator 34 is preferably a high speed alternator. The secondary generator 34 provides 3-phase electrical power to an electrical unit 50 which includes rectifier 52, a DC bus 54 and an AC inverter 56. The rectifier 52 communicates the electrical power to AC Inverter 56 which converts the electrical power to a form or frequency required to match transmission lines 58 requirements. As a result, the turbo-generator 34 supplies rectified DC that is converted directly in AC power. DC electrical power line 34 supplies rectified electrical power to Electrolytic Cell 60 directly.

A by-pass line 38 communicates the exhaust line 30 and the output of the first turbine 22 to the output of the secondary turbine 32, and a valve 36 in line 38 controls the flow of exhaust gas therethrough. A control unit (not shown) could be adapted to control valve 50 to control the output of the secondary turbine 32 as desired.

Turbo-generator 34 may be used in place of motor generator 14 or in conjunction with motor generator 14. If it is used in conjunction with motor generator 14, the rectifier/AC inverter 36 converts the electrical power from 34 to a form or frequency which matches the power generated by generator 14 and transmits it onto the transmission lines 18.

The additional electricity provided by turbo-generator 34 is used to not only reduce or eliminate the demand on power train 16 but it is also used to generate hydrogen and oxygen in water electrolysis system 60 which includes electrolytic cell 62 and hydrogen line 64 and oxygen line 66. Hydrogen is communicated with the air intake line through line 62. Oxygen is communicated with the air intake line through line 64. Since the high amount of hydrogen and oxygen temper the combustion chamber temperature, exhaust gas line 40 and valve 42 are not required. Since the exhaust gas is no longer recirculated, the charge air cooler 26 is no longer required.

Since exhaust gas recirculation 40 is eliminated particulate matter filter 44 is no longer required. With the tempering of the combustion temperature with oxygen and hydrogen addition producing water vapor, selective catalytic reduction 46 of NOₓ or other catalytic combustion is/are no longer required.

Since exhaust gas recirculation is no longer required, turbo-compressor 20 is no longer required. Alternatively, Turbo-compressor 20 may be converted to a turbo-generator 34.

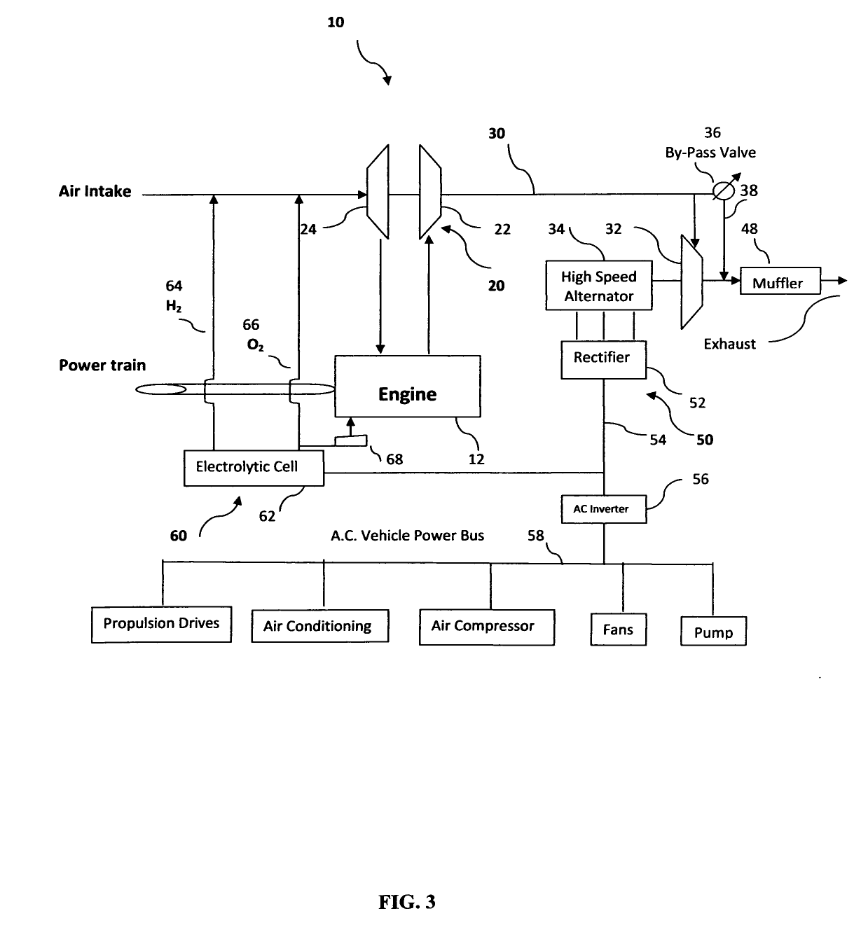

Referring now to FIG. 3, there is shown oxygen pump 68 communicating oxygen from line 66 to the engine cylinders. This separate oxygen feed is beneficial in the event staged combustion is desired to control NOₓ formation.

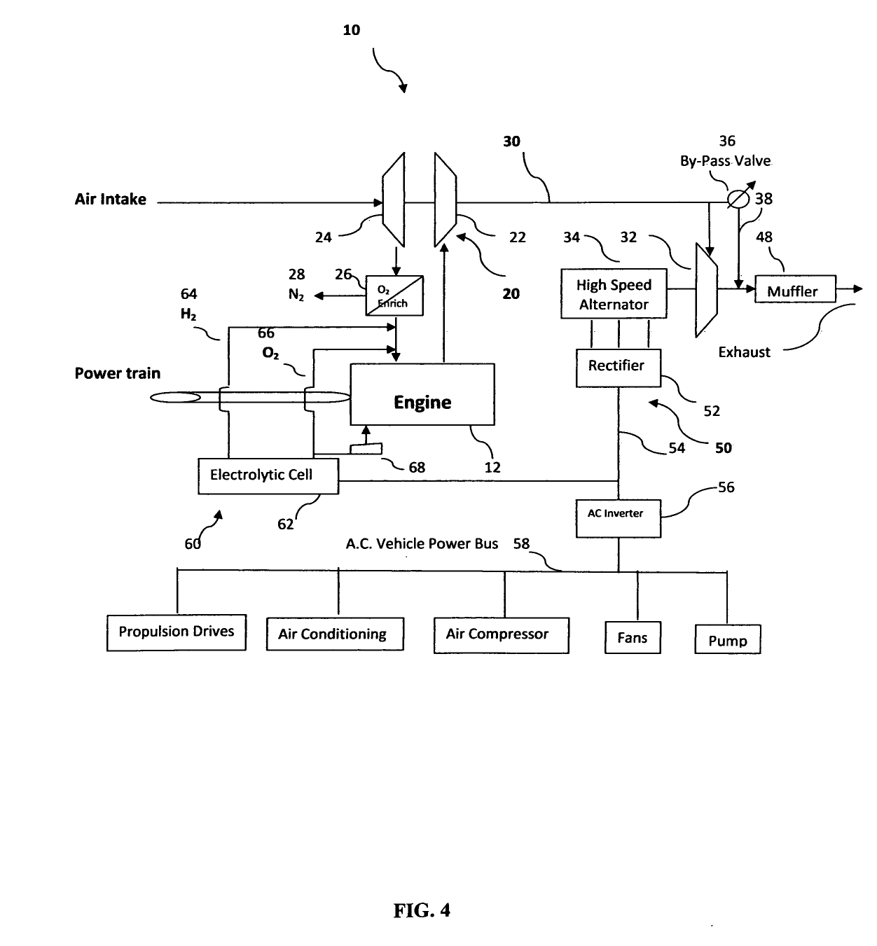

Referring now to FIG. 4, there is shown oxygen enrichment module 26 which reduces or removes nitrogen from the air leaving compressor 24. With the addition of the oxygen enrichment module 26, hydrogen line 62 and oxygen line 64 are preferentially introduced into the engine air intake after the oxygen enrichment module 26.

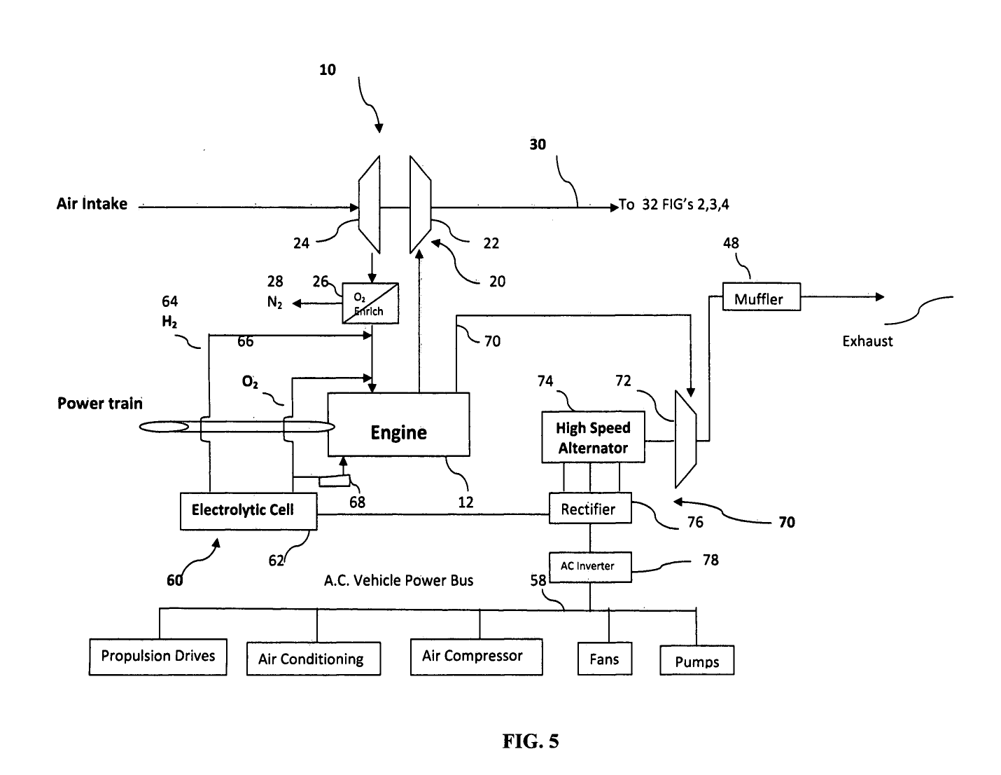

Referring now to FIG. 5, there is shown engine exhaust line 30a communicating with a third turbo-generating system 70 which includes gas turbine 72, a high speed alternator 74, a rectifier 76 and an AC inverter 78. Turbine 72 drives high speed alternator 74. Line 30a is connected to Diesel engine exhaust valves (not shown) which allow the energy from engine braking to be recovered by turbine 72 which communicates with high speed alternator 74. The tertiary high speed alternator 74 provides electrical power to a rectifier 76. The rectifier 76 communicates with AC inverter 78 which converts the electrical power from the high speed alternator 74 to a form or frequency required to match transmission lines 58 requirements. As a result, the turbo-alternator system 70 supplies rectified DC that is converted directly into AC power. DC power communicates directly with electrolytic cell prior to communicating with AC inverter 78.

### Examples

### Baseline Case 100% Diesel Fuel

Basis: Diesel engine running at 60 mph for one hour with fuel mileage 6 mpg; Diesel fuel with a specific gravity of 0.84 and Btu rating of 140,012 Btu/gallon. 10 gallons or 70 lbs of Diesel fuel required per hour. No. 2 Diesel fuel 33° API Ultimate Analysis:

| Element | % in Fuel | Btu/lb | lbs/gallon | Btu/gallon |
|---|---|---|---|---|
| Carbon | 87.30 | 14,093 | 6.111 | 86,122 |
| Hydrogen | 12.60 | 61,100 | 0.882 | 53,890 |
| Oxygen | 0.04 | | | |
| Nitrogen | 0.22 | | | |
| Sulfur | 0.001 | | | 2 |

| | | | |
|---|---|---|---|
| C/H | (6.93) | Total Btu/gallon | 140,014 |

### Combustion Requirements

| | | Air | Air | Nₛ | Nₛ | O₂ | O₂ |
|---|---|---|---|---|---|---|---|
| Element | lbs/gallon | lb/lb | lb/gal | lb/lb | lb/gal | lb/lb | lb/gal |
| Carbon | 6.111 | 11.53 | 70.46 | 8.86 | 54.14 | 2.66 | 16.26 |
| Hydrogen | 0.882 | 34.34 | 30.29 | 26.41 | 23.29 | 7.94 | 7.003 |

For a Diesel Fuel of 87.3% Carbon/12.67% Hydrogen, the CO₂ sensible heat loss is:

0.873 lb C×3.664 lb CO₂/lb C×(878-77)° F.×0.22 Btu/lb° F.=563.67 Btu/lb×7=3,945.7 Btu/gallon

For a Diesel Fuel of 87.3 Carbon/12.6% Hydrogen, the carbon combustion N₂ sensible heat loss is:

0.873 lb C×8.86 lb/N/lb C×801° F.×0.34 Btu/lb N₂° F.=2,106.5 Btu/lb=14,745.4 Btu/gallon

For a Diesel Fuel of 87.3 Carbon/12.6% Hydrogen, the hydrogen combustion N₂ sensible heat loss is:

0.126 lb H×26.41 lb/N/lb H×801° F.×0.34 Btu/lb N₂° F.=906.26 Btu/lb =6,343.8 Btu/gallon

Total Carbon & Hydrogen Combustion N₂ sensible heat loss=3,576 Btu/lb=25,035 Btu/gallon

For a Diesel Fuel of 87.3% Carbon/12.6% Hydrogen, the water vapor sensible heat loss is:

0.126 lb H×8.94 lb H₂O/lb H₂×801×0.45 Btu/lb° F.=406 Btu/lb=2,842.18 Btu/gallon

For a Diesel Fuel of 87.3% Carbon/12.6% Hydrogen, the water vapor latent heat loss is:

0.126 lb H×8.94 lb H₂O/lb H₂×801×1,050 Btu/lb=1,182.8 Btu/lb=8,279.3 Btu/gallon

Total Water Vapor heat loss=1,588.8=11,121.48 Btu/gallon

| SUMMARY | Btu/lb | Btu/gallon |
|---|---|---|
| CO₂ Sensible Heat Loss | 563.67 | 3,945.70 |
| N₂ Sensible Heat Loss | 3,012.76 | 21,089.20 |
| H₂O Sensible Heat Loss | 406.00 | 2,842.12 |
| H₂O Latent Heat Loss | 1,182.80 | 8,279.30 |
| 20% Excess Air | 602.55 | 4,217.84 |
| Total Combustion Gas Btu Loss | 5,767.78 | 40,374.16 |

### Energy Penalty from 50% ERG—Combustion Heat Loss Only; Radiation Losses Not Included

| | | | 50% ERG |
|---|---|---|---|
| SUMMARY | Btu/lb | Btu/gallon | Btu/gal |
| CO₂ Sensible Heat Loss | 563.67 | 3,945.70 | 1,972.85 |
| N₂ Sensible Heat Loss | 3,012.76 | 21,089.20 | 10,544.60 |
| H₂O Sensible Heat Loss | 406.00 | 2,842.12 | 1,421.06 |
| H₂O Latent Heat Loss | 1,182.80 | 8,279.30 | 4,139.65 |
| 20% Excess Air | 602.55 | 4,217.84 | 2,108.92 |
| Total Combustion Gas Btu Loss | 5,767.78 | 40,374.16 | 20,187.08 |

20,187.08 Btu lost÷140,014 Btu/Gallon in purchased fuel=14.42% loss of purchased energy

ERG also prevents preheating of fuel and intake air with lost waste heat.

ERG requires engine to be larger. Elimination of ERG can allow downsizing of engine.

### Hybrid Fuel Example #1 (80% Diesel Fuel/20% Electrolytic Hydrogen & Oxygen)

| Element | % in Mixture | Btu/lb | lbs/mixture | Btu/mixture |
|---|---|---|---|---|
| DF Carbon | 69.84 | 14,093 | 4.8880 | 68,887 |
| DF Hydrogen | 10.08 | 61,100 | 0.7056 | 43,112 |
| EH Hydrogen | 20.00 | 61,100 | 0.4583 | 28,002 |

| | |
|---|---|
| Total Btu/Mixture | 140,001 |

### Latent and Sensible Heat Losses of 80/20 Mixture

| | |
|---|---|
| 80% Diesel Fuel = | 32,299 |
| EH Hydrogen Water Vapor Sensible Heat Losses: | |
| 0.4583 lb H₂ × 8.94 lb H₂O/lb H₂ × 801 × .45 Btu/lb = | 1,477 |
| EH Water Vapor Latent Heat Loss is: | |
| 0.4583 lb H₂ × 8.94 lb H₂O/lb H₂ × 1050 Btu/lb = | 4,302 |
| Total Mixture Latent & Sensible Heat Losses = | 38,078 Btu |
| 100% Diesel Fuel Latent & Sensible Heat Losses= | 40,374 Btu |
| Total Mixture Heat Loss Reduction over 100% Diesel Fuel | 5.7% |

Basis: Diesel engine running at 60 mph for one hour with fuel mileage 6 mpg; Diesel fuel with a specific gravity of 0.84 and Btu rating of 140,012 Btu/gallon. 8 gallons or 56 lbs of Diesel fuel required per hour, 3.6664 lbs of electrolytic Hydrogen and 29.112 lbs of electrolytic Oxygen. No. 2 Diesel fuel used was 33° API gravity.

$$3.664 lbs of electrolytic Hydrogen = 1 \text{,} 664.55 grams \text{/} hour$$

$$29.122 lbs of electrolytic Oxygen = 13 \text{,} 216.85 grams \text{/} hour$$

$$Grams of water / hours$$

$$14 \text{,} 8841.40 grams \text{/} hour = 32.78 lbs or 3.93 gallons \text{/} hour$$

Electrolyzing water into Hydrogen and Oxygen@100% efficiency=26.8 amps/gram Eq. Wt. Hydrogen gram Eq. Wt.=1.0079/26.8 amp/hours. Oxygen is a free co-product.
1,664.55 grams of Hydrogen/hour=44,260.28 amp hours

### @1.23 v (Theoretical Efficiency)=54.44 Kwh

@2.00 v=88.41 Kwh
@2.50 v=110.65 Kwh
@3.00 v=132.78 Kwh

### Energy Savings Summary for Example #1

| | |
|---|---|
| Fuel Reduction by Hydrogen Replacement | 20.00% Savings |
| Engine Efficiency Improvement O₂ in place of air | 5.70% Savings |
| TOTAL SAVINGS | 25.70% Savings |

### Hybrid Fuel Example #2 (100% Diesel Fuel with Oxygen Enrichment of Combustion Intake Air)

### Combustion Requirements

| | | Air | Air | Nₛ | Nₛ | O₂ | O₂ |
|---|---|---|---|---|---|---|---|
| Element | lbs/gallon | lb/lb | lb/gal | lb/lb | lb/gal | lb/lb | lb/gal |
| Carbon | 6.111 | 11.53 | 70.46 | 8.86 | 54.14 | 2.66 | 16.26 |
| Hydrogen | 0.882 | 34.34 | 30.29 | 26.41 | 23.29 | 7.94 | 7.003 |

For a Diesel Fuel of 87.3% Carbon/12.67% Hydrogen, the CO₂ sensible heat loss is:

0.873 lb C×3.664 lb CO₂/lb C×(878-77)° F.×0.22 Btu/lb° F.=563.67 Btu/lb×7=3,945.7 Btu/gallon

For a Diesel Fuel of 87.3% Carbon/12.67% Hydrogen, the 4% excess O₂ sensible heat loss is:

0.873 lb C×0.04% O₂/lb C×(878-77)° F.×0.22 Btu/lb° F.=6.15 Btu/lb×7=43,08 Btu/gallon

For a Diesel Fuel of 87.3% Carbon/12.6% Hydrogen, the carbon combustion N₂ sensible heat loss is:

0 Btu/lb=0 Btu/gallon

For a Diesel Fuel of 87.3% Carbon/12.6% Hydrogen, the nitrogen combustion N₂ sensible heat loss is:

0 Btu/lb=0 Btu/gallon

Total Carbon and Hydrogen Combustion N₂ sensible heat loss=0 Btu/lb=0 Btu/gallon

For a Diesel Fuel of 87.3% Carbon/12.6% Hydrogen, the water vapor sensible heat loss is:

0.126 lb H×8.94 lb H₂O/lb H₂×801×0.45 Btu/lb° F.=406 Btu/lb=2,842.18 Btu/gallon

For a Diesel Fuel of 87.3% Carbon/12.6% Hydrogen, the water vapor latent heat loss is:

0.126 lb H×8.94 lb H₂O/lb H₂×801×1,050 Btu/lb=1,182.8 Btu/lb=8,279.3 Btu/gallon

Total Water Vapor heat loss=1,588.8=11,121.48 Btu/gallon

| SUMMARY | Btu/lb | Btu/gallon |
|---|---|---|
| CO₂ Sensible Heat Loss | 563.67 | 3,945.70 |
| N₂ Sensible Heat Loss | 0 | 0 |
| H₂O Sensible Heat Loss | 406.00 | 2,842.12 |
| H₂O Latent Heat Loss | 1,182.80 | 8,279.30 |
| 4% Excess Oxygen | 6.15 | 43.08 |
| Total Combustion Gas Btu Loss | 2,158.62 | 15,110.20 |

15,110.20 Btu/gallon Combustion Gas Heat loss versus Baseline Total Combustion Gas Btu loss of 40,374.16=62.57% reduction of Combustion Gas Heat Loss. Baseline Combustion Gas Heat Loss is 28.84% of the total engine energy input. Oxygen enriched Combustion Gas Heat Loss is 10.79% of the total engine energy input. Therefore, the efficiency improvement with oxygen enrichment is 18.05%.

### Hybrid Fuel Example #3 (80% Diesel Fuel/20% Electrolytic Hydrogen & Oxygen with Oxygen Enrichment of Combustion Intake Air)

### Energy Savings Summary for Example #3

| | |
|---|---|
| Fuel Reduction by Hydrogen Replacement | 20.00% Savings |
| Engine Efficiency Improvement 100% O₂ in place of air | 18.05% Savings |
| TOTAL SAVINGS | 38.05% Savings |

### Hybrid Fuel Example #4 (80% Diesel Fuel/20% Electrolytic Hydrogen & Oxygen with Oxygen Enrichment of Combustion Intake Air and Elimination of ERG)

### Energy Savings Summary for Example #4

| | |
|---|---|
| Fuel Reduction by Hydrogen Replacement | 20.00% Savings |
| Exhaust Gas Recirculation, and CAC elimination | 14.42% Savings |
| Engine Efficiency Improvement 100% O₂ in place of air | 18.05% Savings |
| TOTAL SAVINGS | 52.47% Savings |

Notes:
(1) Electricity to electrolyze water can be from a turbo-generator in the exhaust gas.
(2) Additional electricity to electrolyze water can be from a turbo-generator on the exhaust valves during engine braking.
(3) Exhaust Turbo-Compressor can be used for intake air oxygen enrichment.

While the above description contains many specificities, these should not be construed as limitations on the scope of any embodiment, but as exemplifications of various embodiments thereof. Many other ramifications and variations are possible within the teaching of the various embodiments. For example, the basic principles of the invention may be utilized in any vehicle, train, boat, or any device that utilizes an engine. Furthermore, even devices that do not move such as generators may utilize one or more of the principles set forth above. Benefits of the invention include a reduced thermal and radar signature of a vehicle operating with the invention and increased electrical power for auxiliary electronics. Accordingly, the appended claims and their legal equivalents should only define the invention, rather than any specific examples given.

Thus, the scope should be determined by the appended claims and their legal equivalents, and not by the examples given.

I claim:

1. A system for use in connection with an engine operating in an open-loop energy cycle, said system comprising: an engine, an waste energy conduit extending from said engine, a generator that receives energy from the from the waste energy conduit, an electrolysis unit that separates water into hydrogen and oxygen that is powered from the generator; wherein the oxygen generated by the electrolysis unit is provided to the engine for fuel combustion and wherein the hydrogen generated by the electrolysis unit is provided to the engine for combustion with the fuel.

2. The system of claim 1, wherein the generator is a turbo-generator that receives energy from the waste energy conduit and generates electricity for use in said electrolysis unit that separates water into hydrogen and oxygen.

3. The system of claim 1, wherein the generator is a thermo-electric module that receives energy from the waste energy conduit or other waste energy, and generates electricity for use in said electrolysis unit that separates water into hydrogen and oxygen.

4. The system of claim 1, wherein the generator is a turbine that receives energy in a closed loop recovering waste energy from the engine system.

5. The system of claim 1, wherein the generator is an expander that receives energy from the waste energy conduit or other waste energy, and generates electricity for use in said electrolysis unit that separates water into hydrogen and oxygen.

6. The system of claim 1, wherein a reformation unit that reforms fuel with hydrogen for use by the engine.

7. The system of claim 1, wherein in the engine has one or zero parasitic loads which said parasitic loads are met by the electricity produced by said generators.

8. The system of claim 1, wherein the generator, electrolysis unit and reformation unit are computer controlled.

9. The system of claim 1, wherein oxygen is partially or totally injected directly into the cylinders in the power stroke cycle.

10. The System of claim 1, wherein the fuel and air or oxygen are lean to produce a reducing combustion environment.

11. The system of claim 1, wherein combustion make-up air is pretreated to substantially eliminate nitrogen using oxygen enrichment membranes.

12. The system of claim 1, wherein make-up air is pretreated to substantially eliminate nitrogen from the air using molecular sieves.

13. The system of claim 1, wherein make-up air is pretreated to substantially eliminate nitrogen from the air using cryogenic air separation methods.

14. The system of claim 1, wherein oxygen is injected prior to Particulate Matter Filter to complete combustion or eliminate need for PMF.

15. The system of claim 11, wherein the generator recovers waste energy from the muffler and/or exhaust pipe and generates electricity to satisfy the parasitic load and/or the electrolyzer.

16. The system of claim 1, wherein the generator recovers waste energy from engine braking energy.

17. The system of claim 1, wherein electricity for parasitic load and/or electrolyzer is from regenerative braking.

18. The system of claim 1, wherein electricity for parasitic load and/or electrolyzer is from regenerative shock absorbers.

19. The system of claim 1, wherein hydrogen and fuel are reformed directly within the cylinder by preheating the fuel, the hydrogen or both.

20. The method of claim 1, wherein Exhaust Gas Recirculation, is substantially reduced or eliminated by reducing the combustion temperature below the critical point where nitrous oxides are formed; said temperature reduction being allowed by changing the combustion gas composition to one that is high is water vapor and carbon dioxide and allowing in-cylinder nitrous oxide formation control.
